(19) United States
(12) Patent Application Publication
(10) Pub. No.: US 2021/0100717 A1
(43) Pub. Date: Apr. 8, 2021

(54) HANDS FREE, WHOLE BODY, SELF MASSAGE AND CORE STRENGTHENING DEVICE

(71) Applicant: Cameron Beck, Surrey (CA)

(72) Inventor: Cameron Beck, Surrey (CA)

(21) Appl. No.: 17/062,417

(22) Filed: Oct. 2, 2020

Related U.S. Application Data
(60) Provisional application No. 62/910,010, filed on Oct. 3, 2019.

(51) Int. Cl. A61H 7/00; A61H 15/00; A63B 23/02

(52) U.S. Cl. CPC A61H 7/002; A61H 15/00; A63B 23/0205; A61H 2201/0157; A61H 2201/0192; A61H 2201/1261; A61H 2201/0119

(57) ABSTRACT

A massage device is disclosed herein. The massage device includes a base assembly, the base assembly configured to be disposed on a support surface; at least one pole member configured to be coupled to the base assembly, the at least one pole member configured to extend upwardly from a top surface of the base assembly; and at least one massage head configured to be selectively coupled to the at least one pole member by a user, the selective coupling of the at least one massage head to the at least one pole member enabling the massage device to provide a massage to various parts of a user's body.

### CROSS-REFERENCE TO RELATED APPLICATIONS

This patent application claims priority to, and incorporates by reference in its entirety, U.S. Provisional Patent Application No. 62/910,010, entitled “HANDS FREE, WHOLE BODY, SELF MASSAGE AND CORE STRENGTHENING DEVICE”, filed on Oct. 3, 2019.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF THE INVENTION

### 1. Field of the Invention

The present disclosure relates generally to alternatives to massage devices. More particularly the present device relates to hands free static free-standing massage devices. Even more particularly, the present disclosure relates to a highly customizable massage device requiring no power other than interaction by the user.

### 2. Background

There are many massage devices in various configurations. A field of massage devices includes manual or non-powered devices, which provide the advantages of not requiring batteries or an electrical outlet, and being less prone to breaking down due to lower complexity and hardier construction, generally. There are many configurations of balls and bumps and protuberances, but there are no devices or systems which are freestanding and provide massage heads adapted to efficiently employ the weight of a user in a hands-free massage. There is also a dearth of free-standing customizable massage apparatus for all heights of user.

There is, therefore, a need for a system which provides an inexpensive, customizable, heavy duty, reliable, free standing massage device with multiple massage head options, which may be reconfigured to provide an optimum massage device for height and weight and body type characteristics for individual users.

### BRIEF SUMMARY OF EMBODIMENTS OF THE INVENTION

Accordingly, the present invention is directed to a massage device that substantially obviates one or more problems resulting from the limitations and deficiencies of the related art.

In accordance with one or more embodiments of the present invention, there is provided a massage device that includes a base assembly, the base assembly configured to be disposed on a support surface; at least one pole member configured to be coupled to the base assembly, the at least one pole member configured to extend upwardly from a top surface of the base assembly; and at least one massage head configured to be selectively coupled to the at least one pole member by a user, the selective coupling of the at least one massage head to the at least one pole member enabling the massage device to provide a massage to various parts of a user's body.

In a further embodiment of the present invention, the base assembly further comprises a base platform member and a base bracket member attached to the base platform member, the base platform member configured to accommodate the user in a standing position thereon such that a weight of the user enhances a structural stability of the massage device and prevents the massage device from tipping or falling over during use, and the base bracket member configured to couple the at least one pole member to the base platform member.

In yet a further embodiment, the base bracket member of the base assembly comprises at least one pole receiver element configured to be coupled to a lower end of the at least one pole member.

In still a further embodiment, the base platform member of the base assembly comprises a handle cutout for facilitating a carrying of the massage device during transportation thereof by the user.

In yet a further embodiment, the base platform member of the base assembly further comprises a plurality of feet for balancing the base platform member and preventing damage to floor surfaces.

In still a further embodiment, the at least one pole member comprises a plurality of telescoping pole members for enabling a vertical extending height of the massage device to be selectively adjusted by the user so as to reach the various parts of the user's body.

In yet a further embodiment, the plurality of telescoping pole members comprise a first lower pole member, a second intermediate pole member, and a third upper pole member, the second intermediate pole member being telescopically received in the first lower pole member, and the third upper pole member being telescopically received by the second intermediate pole member so as enable the vertical extending height of the massage device to be selectively adjusted by the user.

In still a further embodiment, a selected position of the second intermediate pole member relative to the first lower pole member is configured to be maintained by a first position locking device, and a selected position of the third upper pole member relative to the second intermediate pole member is configured to be maintained by a second position locking device.

In yet a further embodiment, at least one of the first position locking device and the second position locking device comprises a snap button spring clip.

In still a further embodiment, the at least one massage head comprises a plurality of massage heads rotatably and/or pivotably attached a massage bracket member, the massage bracket member configured to be coupled to the at least one pole member by a connector member.

In yet a further embodiment, the at least one pole member comprises a plurality of holes disposed along a length thereof, and wherein the connector member is configured to be inserted by the user into a selected one of the plurality of holes disposed along the length of the at least one pole member so as to enable the massage device to provide a hands free massage to the various parts of the user's body.

In still a further embodiment, the connector member has a cross-sectional size that is less than an opening size of the plurality of holes of the at least one pole member so as to enable the massage bracket member with the plurality of massage heads to rotate and/or pivot relative to the at least one pole member, while still support a portion of the user's weight applied to the massage bracket member.

In yet a further embodiment, the at least one massage head further comprises an oblate spheroid massage head with a connector post configured to be inserted into a top end of the at least one pole member.

In still a further embodiment, the at least one pole member is configured to be disassembled from the base assembly by the user without the use of tools so that the massage device is able to be easily and compactly transported and stored.

In yet a further embodiment, the selective coupling of the at least one massage head to the at least one pole member enables the massage device to be selectively configured into a plurality of different functional positions, the plurality of different functional positions being selected from the group consisting of: (i) an upper back massage position; (ii) a neck and head massage position; (iii) a calf and head massage position; (iv) a foot and head massage position; (v) a neck, head and foot massage position; (vi) a glutes and hamstring position; (vii) a golf swing training position; (viii) a mid and lower back, and foot massage position; (ix) a neck, shoulders and calf massage position; (x) an upper back, shoulders and foot massage position; (xi) an upper back, shoulders and head massage position; and (xii) combinations thereof.

In still a further embodiment, while providing a massage to the various parts of the user's body, the massage device is configured to simultaneously strengthen core muscles of the user's body.

In yet a further embodiment, the massage device is configured to be portable, transportable, and free-standing without attachment to a building support element.

It is to be understood that the foregoing general description and the following detailed description of the present invention are merely exemplary and explanatory in nature. As such, the foregoing general description and the following detailed description of the invention should not be construed to limit the scope of the appended claims in any sense.

### BRIEF DESCRIPTION OF THE SEVERAL VIEWS OF THE DRAWINGS

The invention will now be described, by way of example, with reference to the accompanying drawings, in which:

FIG. 1 shows the free-standing massage device in assembled format, for a tall person or user in accordance with an embodiment of the present disclosure.

FIG. 2 shows the device in the assembled storage configuration in accordance with an embodiment of the present disclosure.

FIG. 3 shows the device in the upper back massage position in accordance with an embodiment of the present disclosure.

FIG. 4 shows the device in the neck and head massage position in accordance with an embodiment of the present disclosure.

FIG. 5 shows the device in the calf and head massage position in accordance with an embodiment of the present disclosure.

FIG. 6 shows the device in the foot and head massage position in accordance with an embodiment of the present disclosure.

FIG. 7 shows the device in the collapsed, transport configuration in accordance with an embodiment of the present disclosure.

FIG. 8 is a perspective view of the self-massage and core strengthening device with two embodiments of adjustably joined massage appliances.

FIG. 9 is a magnified side view of the orientation of fasteners used to secure perpendicular base post receiver to base platform.

FIG. 10 is a top view of a base platform and the positioning of the perpendicular base post receiver in relation to carry handle.

FIG. 11 is a bottom view of the base platform showing position of base platform stabilizing legs and position of holes allowing perpendicular base post receiver to be secured to base platform with fasteners.

FIG. 12 is a side view of the perpendicular base post receiver, base platform and base platform stabilizing legs.

FIG. 13 is a perspective view of the perpendicular base post receiver.

FIG. 14 is a side view of the perpendicular base post receiver denoting fusion of post receivers' perpendicular to post receiver base.

FIG. 15 is a perspective view of the lower (outer) tube section of the multi-section telescoping post with a plurality of holes for adjustment of the multi-section telescoping post with a cope at the top end of the lower (outer) tube section.

FIG. 16 is a perspective view of the middle (inner) tube section with a plurality of holes for adjustment of the multi-section telescoping post. Dashed lines denote orientation of single button spring clips mounted inside the middle (inner) section of the multi-section telescoping post with a cope at the bottom end of the middle (inner) tube section.

FIG. 17 is a perspective view of the upper (outer) tube section of the multi-section telescoping post with a plurality of holes for adjustment. Tube is coped at bottom end of upper (outer) tube section.

FIG. 18 is a side view with a cut away of the relationship between an adjustable 4 ball massage device, the mounting pin for adjustment holes in tube sections.

FIG. 19 is a magnified view of an adjustable ball massage device backing plate, mounting pin and fasteners.

FIG. 20 is a rear view of an adjustable 4 ball backing plate, balls for massage and fasteners.

FIG. 21 is a perspective view of adjustable 4 ball massage device adjustment mounting pin.

FIG. 22 is a side view of adjustable 4 ball massage device adjustment mounting pin.

FIG. 23 shows single button spring clips used for locking the tube sections in place.

FIG. 24 is a perspective view of an oblate spheroid massage device.

FIG. 25 is a close up of the top end of the telescoping pole or extension pole with massage bracket and four heads and single oblate spheroid on top.

FIG. 26 is a close up left side view of the telescoping pole or extension pole with massage bracket and four heads and single oblate spheroid on top.

FIG. 27 is a close up left side view of the massage bracket and four heads.

FIG. 28 is a close up left rear view of the massage bracket and four heads.

FIG. 29 shows the device in a neck, head and foot massage position in accordance with an embodiment of the present disclosure.

FIG. 30 shows the device in a glutes and hamstring position in accordance with an embodiment of the present disclosure.

FIG. 31 shows the device in a golf swing training position in accordance with an embodiment of the present disclosure.

FIG. 32 shows the device in a mid and lower back, and foot massage position in accordance with an embodiment of the present disclosure.

FIG. 33 shows the device in a neck, shoulders and calf massage position in accordance with an embodiment of the present disclosure.

FIG. 34 shows a bottom view of the device in its stored position in accordance with an embodiment of the present disclosure.

FIG. 35 shows a top view of the device in its stored position in accordance with an embodiment of the present disclosure.

FIG. 36 shows the device in an upper back, shoulders and foot massage position in accordance with an embodiment of the present disclosure.

FIG. 37 shows the device in an upper back, shoulders and head massage position in accordance with an embodiment of the present disclosure.

FIG. 38 shows a close up top view of the stored position in accordance with an embodiment of the present disclosure.

Corresponding reference characters indicate corresponding components throughout the figures. Elements in the figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood, elements that are useful or necessary in a commercially feasible embodiment are often not depicted in order to facilitate a less obstructed view of these various embodiments of the present disclosure.

Throughout the figures, the same parts are always denoted using the same reference characters so that, as a general rule, they will only be described once.

### DETAILED DESCRIPTION OF EMBODIMENTS OF THE INVENTION

The following description is not to be taken in a limiting sense, but is made merely for the purpose of describing the general principles of exemplary embodiments. The scope of the disclosure should be determined with reference to the Claims. Reference throughout this specification to “one embodiment,” “an embodiment,” or similar language denotes that a particular feature, structure, or characteristic, described in connection with the embodiment, is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description numerous specific details are provided for a thorough understanding of embodiments of the disclosure. One skilled in the relevant art will recognize, however, that the embodiments of the present disclosure can be practiced without one or more of the specific details, or with other methods, components, materials, and so forth, and still remain encompassed by the present disclosure. In other instances, well-known structures, materials, or operations are not shown or described in detail to avoid obscuring aspects of the present disclosure.

In one or more embodiments, as explained in detail hereinafter, a massage device is adaptable to provide massage to various parts of the body by permitting multiple massage devices to be attached thereto. The massage heads are interconnected or supported by the device through a mounting bracket that is gimballed or otherwise has a swivel type connection allowing the user to pivot the massage heads to a desired position. The device is adaptable in height with the use of multiple poles, such as a lower pole, an upper pole and an extension pole positioned therebetween. A platform supports the device and supports the user of the device, such that the weight of the user provides structurally integrity and prevents the device from tipping or falling over during use.

In one or more embodiments, the massage device is a manually operated self-massage apparatus which uses one's own energy to target/pinpoint for therapeutic massage of stressed muscles, self myofascial release of tension in sore, aching muscles, stimulation of acupressure points throughout the human body, while simultaneously strengthening core muscles.

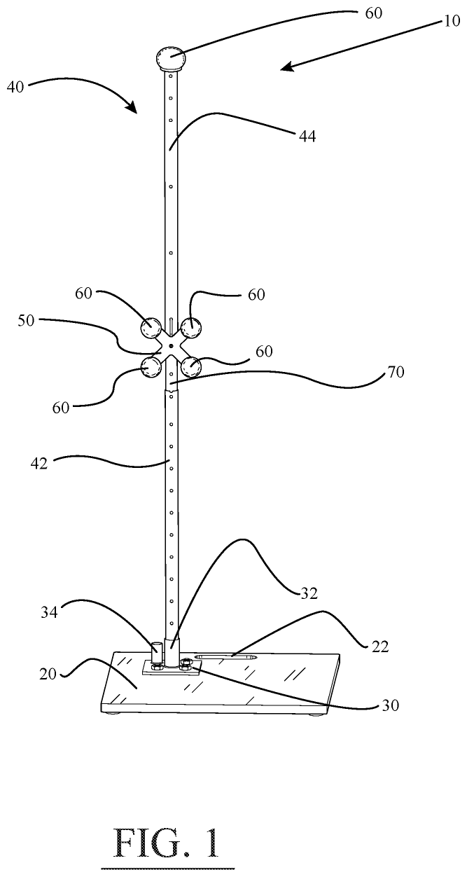

Referring to FIG. 1, the free-standing massage device 10 is shown in assembled format, for a tall person or user. The platform 20 provides a stable area for the user to stand on while massaging, and also prevents the device 10 from tipping over during the massage, while the user applies force to the massage heads 60 on the pole 40. The platform 20 is ideally of a laminated wood so that it is light yet durable. It is optimally at least 609 mm by 609 mm in dimension, but may be larger or smaller. The platform 20 ideally has a handle hole 22 cut into it for ease of transportation by the user. The platform also includes a rubber, plastic or other suitable material foot 24 underneath each corner of the platform 20 to balance the platform and avoid damage to floor surfaces.

A base 30 is bolted or otherwise attached to the platform. A receiver 32 extends vertically from the base 30 and is ideally tubular steel and sufficiently tall, for instance 114 mm, in order that it may receive and securely house the pole 40. A short storage receiver 34 is also attached to the base and extends vertically from the base 30. The storage receiver 34 is sized to receive the upper pole 44 when not in use, to reduce the height of the device 10.

The pole 40 ideally comprises two pole segments, a lower pole 42 and an upper pole 44. The lower pole 42 extends substantially vertically from the base 30 and receiver 32, and terminates at its distal end 43 in a short length of slightly smaller diameter pole, with, optimally, a push to connect fit and button locking mechanism 46 which is known. This securely attaches the upper pole 44 to the lower pole 42 to assemble the full height device 10.

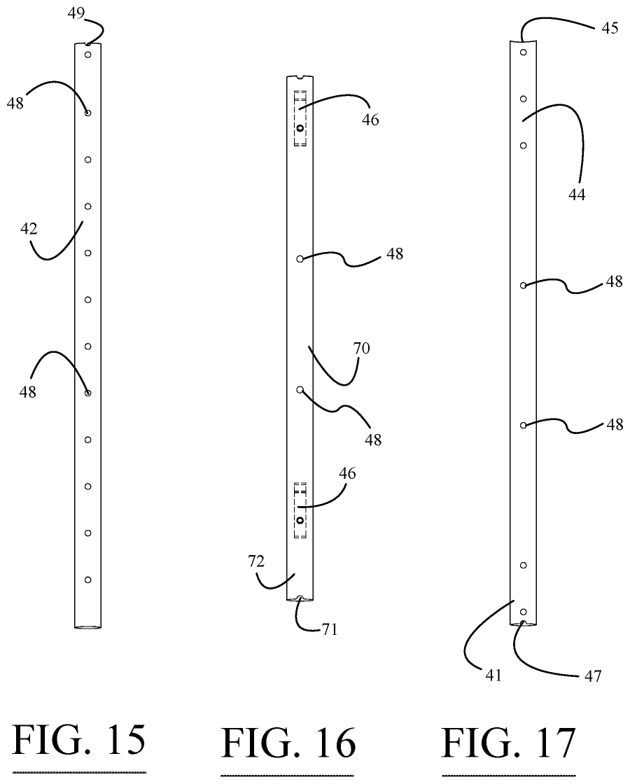

A plurality of holes are disposed along the vertical length of the pole 40 at intervals determined to be optimal, through experimentation, for a broad range of human users. The intervals are, optimally, at the center point and every 50.8 mm, measured from the platform 20. Different hole 48 configurations may be used (see FIG. 15).

A massage bracket 50 is provided which is comprised, optimally, of an “X” or cross of steel, with a thickness of 4 mm and outer dimensions of 101 mm by 101 mm. Each branch of the “X” or cross is approximately 19.5 mm wide. These dimensions have been determined through experimentation to be the optimal compromise between weight and the necessary resilience for a wide range of human users.

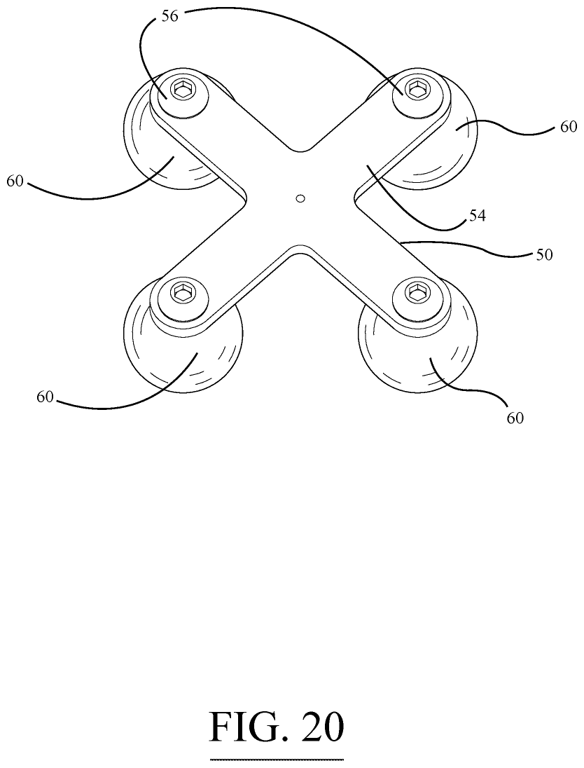

The massage bracket 50 has a face 52 and a back surface 54 (see FIG. 20). At each distal end of the four tangs or wings of the cross, there is a connector 56 of any known type, including threaded post, bayonet connector, or snap connector, for instance. The connector 56 is adapted to receive a massage head 60, which in this figure is a flattened ball, with a width or diameter greater than its height, which has been determined to be optimal as a massage tool. The connector is gimballed or has a swivel, such that when pressure or force is applied to the head 60, it can rotate and also, to some degree, swivel. Optimally, the head can swivel up to 10 degrees from the vertical plane.

A connector or hook 58, usually a bent bar, extends substantially horizontally from the back 54 of the bracket 50, and has a turn approximately 90 degrees and is then disposed downwards toward the platform, and is adapted to be inserted in any one of the holes 48 in the pole 40. The hook 58 connecter is of a smaller diameter than that of the holes 48, thereby providing a gimballed or swivel effect, and it can move up, down and/or side to side, yet can support a substantial weight. The bracket 50 in FIG. 1 is disposed at waist height for a tall human, so that a person can push his or her back against the 4 heads 60 for a lower back massage. A great deal of force may be applied to the resilient massage device 10 simply by the user leaning against the heads 60, resulting in a deep muscle massage, including for therapeutic purposes, without the need of power or complex components.

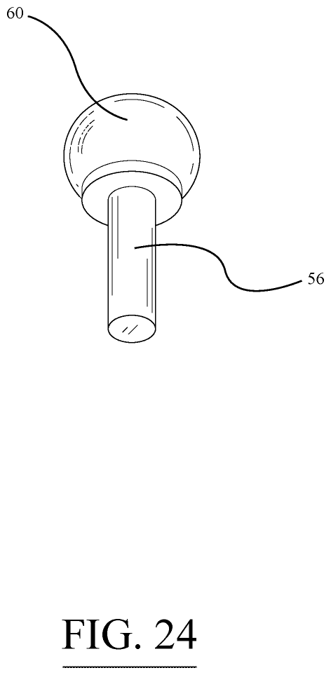

At the top end of the pole 40, a connector 56 (see FIG. 24) is provided to receive, optimally, a single massage head 60 or ball. This is adapted for use to massage a person's neck.

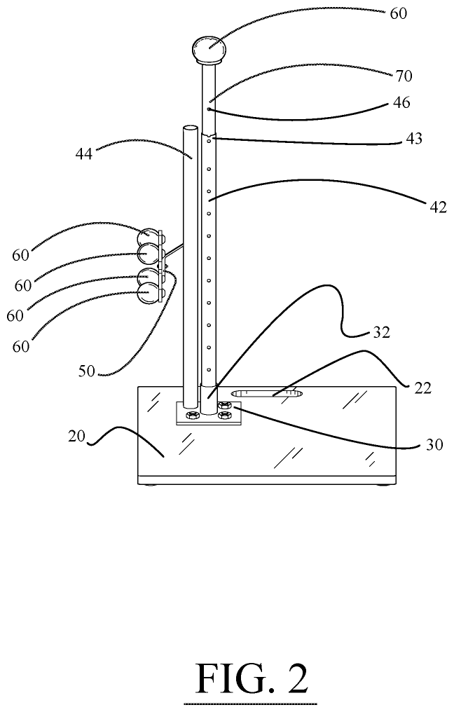

FIG. 2 shows the device 10 in the assembled storage configuration, with the upper pole 44 disconnected from the lower pole 42 and inserted over the storage receiver 34. This is a typical storage configuration in a user's house or gym. FIG. 2 shows the telescoping option whereby a smaller dimension extension pole 70 is provided which can be raised or lowered then retained in an ideal position for the user's neck or other muscles, as desired.

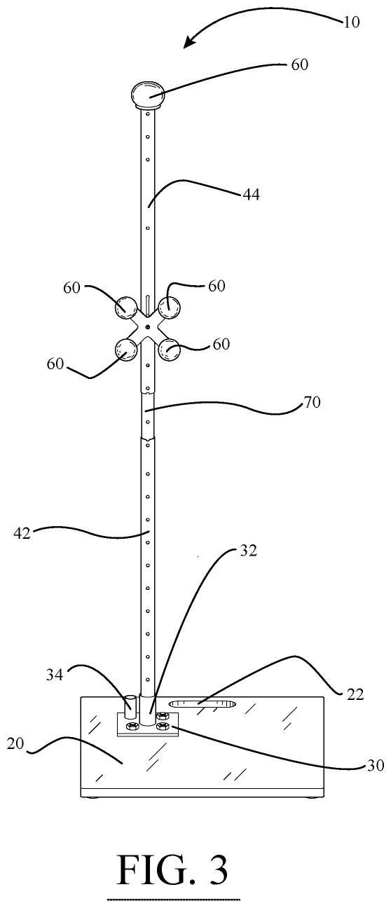

FIG. 3 shows the device 10 in the upper back massage position.

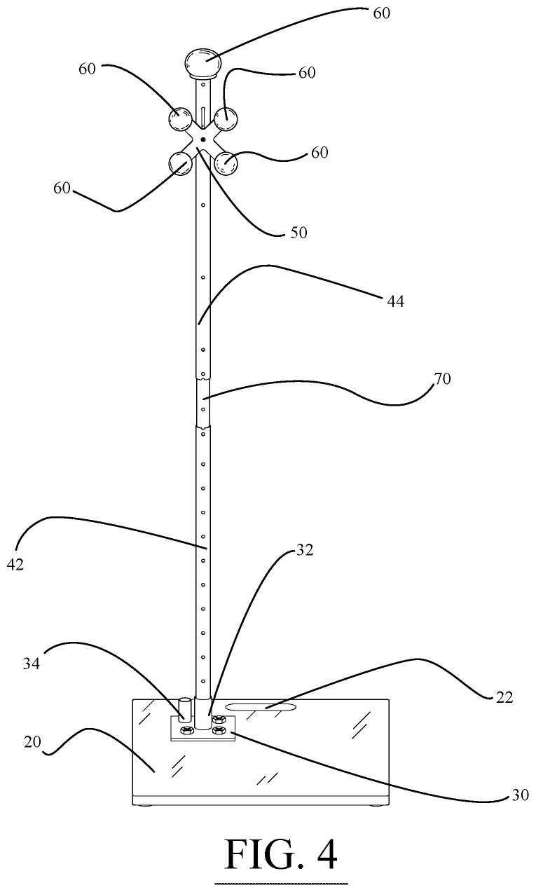

FIG. 4 shows the device 10 in the neck and head massage position.

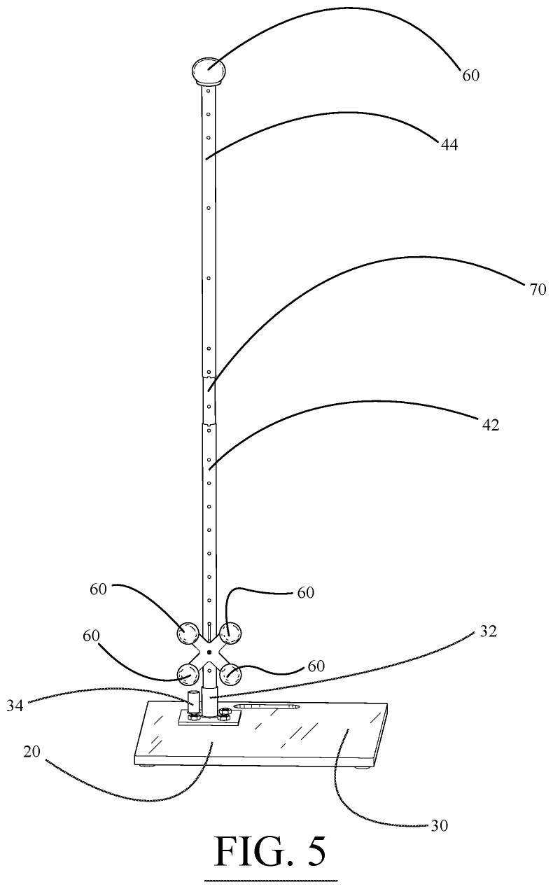

FIG. 5 shows the device 10 in the calf and head massage position.

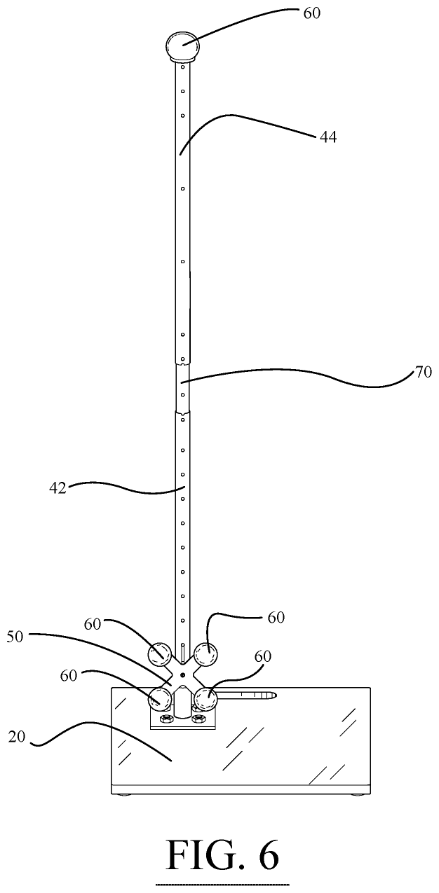

FIG. 6 shows the device 10 in the foot and head massage position.

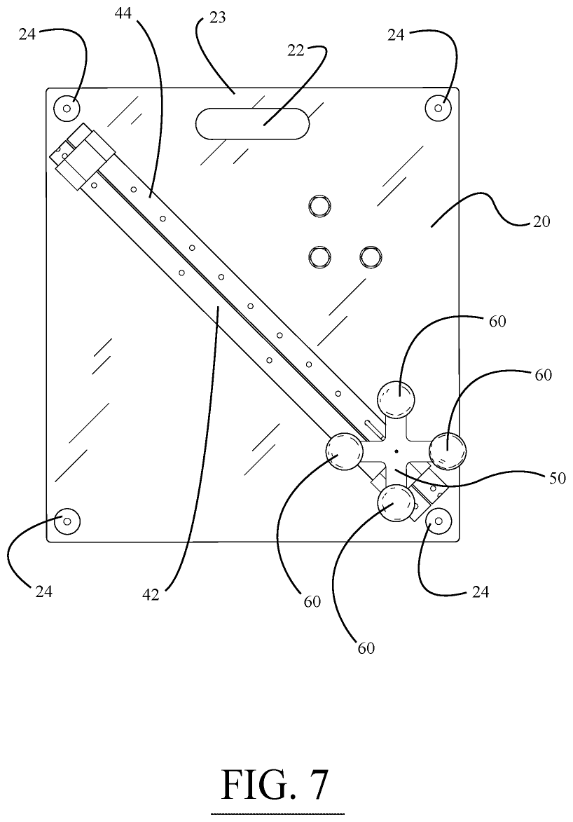

FIG. 7 shows the device 10 in the collapsed, transport configuration. The two poles 42, 44 have been disassembled and strapped to the underside of the platform 20, with the bracket 50 and heads 60 still attached. A user may simply grasp the platform by the handle 23 created by the handle hole 22 and easily move the entire device to another location.

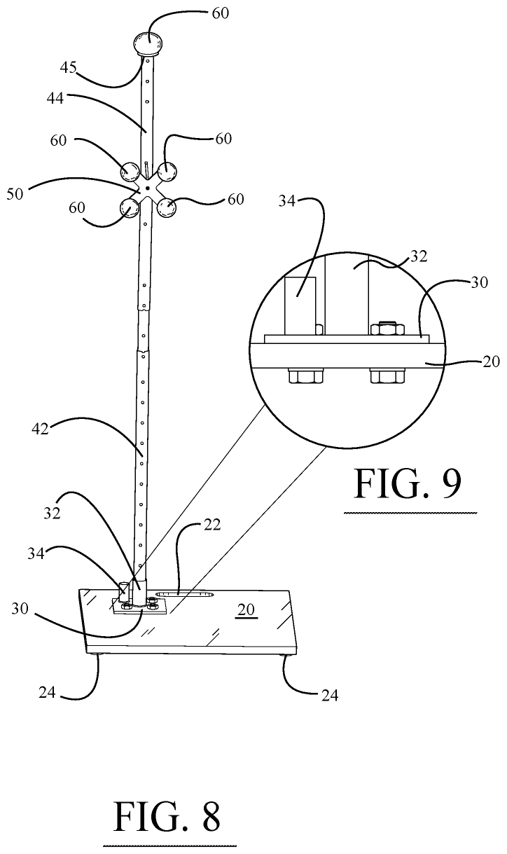

FIG. 8 is a perspective view of the device in the upper back massage position, illustrating the pole 40 secured to the platform 20 via the base 30, and the lower pole 42 operatively secured to the base 30 by the receiver 32. Also illustrated herein is the “X” shaped massage bracket 50, secured to the upper pole 44, with each branch or arm of the “X” bracket 50 having a massage head 60 connected thereto. A fifth massage head 60 is also shown to be connected to a distal end 45 of the upper pole 44.

FIG. 9 is a magnified side view of the orientation of fasteners used to secure perpendicular base post receiver 30 to base platform 20.

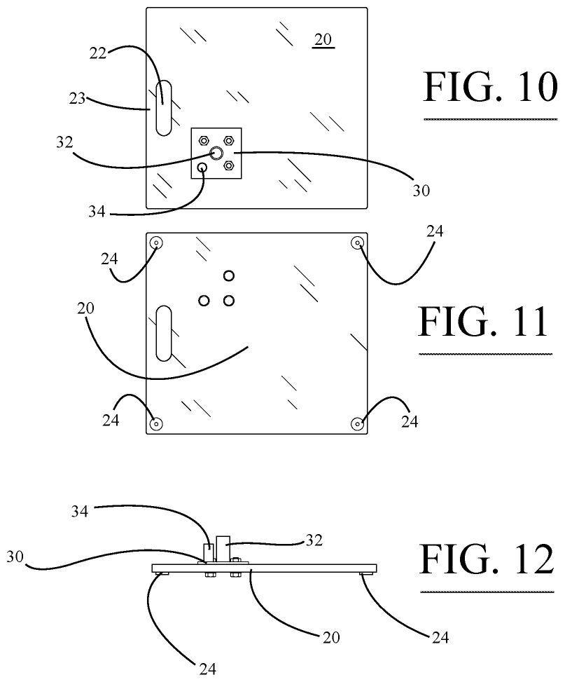

FIG. 10 is a top view of a base platform 20 and the positioning of the perpendicular base post receiver 32 in relation to carry handle 23.

FIG. 11 is a bottom view of the base platform 20 showing position of base platform stabilizing legs 24 and position of holes allowing perpendicular base 30 to be secured to base platform 20 with fasteners.

FIG. 12 is a side view of the perpendicular base post receivers 32, 34, base platform 20 and base platform stabilizing legs 24.

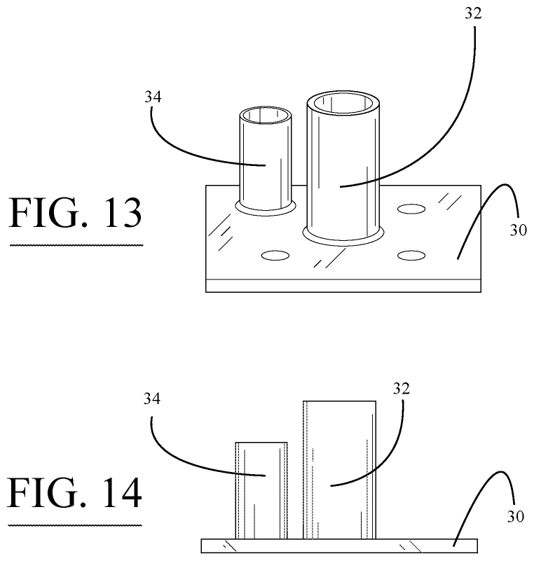

FIG. 13 is a perspective view of the base 30 having the perpendicular base post receivers 32, 34, complete with holes for mounting.

FIG. 14 is a side view of the base 30 having the perpendicular base post receivers 32, 34, denoting fusion of post receivers' perpendicular to post receiver base 30.

FIG. 15 is a perspective view of the lower (outer) pole 42 of the multi-section telescoping pole 40 with a plurality of holes 48 for adjustment of the multi-section telescoping pole 40 with a cope 49 at the top end of the lower (outer) pole 42.

FIG. 16 is a perspective view of the middle (inner) tube section or extension pole 70 with a plurality of holes 48 for adjustment of the multi-section telescoping pole 40. Dashed lines denote orientation of single button spring clips or button lock 46 mounted inside the extension pole 70 with a cope 71 at a bottom end 72 of the extension pole 70.

FIG. 17 is a perspective view of the upper (outer) tube section or upper pole 44 of the multi-section telescoping pole 40 with a plurality of holes 48 for adjustment. The upper pole 44 has a cope 47 at bottom end 41 thereof.

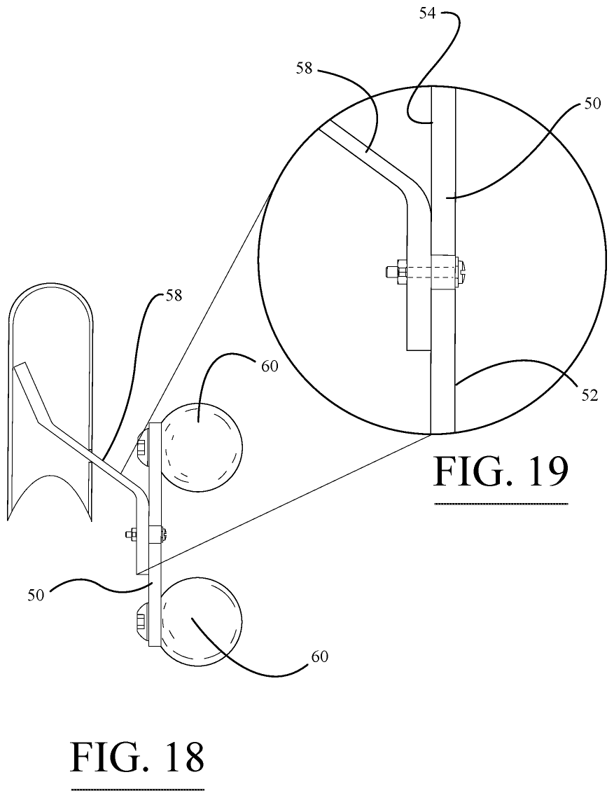

FIG. 18 is a side view with a cut away of the relationship between an adjustable 4 ball massage bracket 50, mounting hook 58 for adjustment holes in tube sections.

FIG. 19 is a magnified view of an adjustable ball massage bracket 50, mounting hook 58 and fasteners.

FIG. 20 is a rear view of an adjustable 4 ball massage bracket 50, massage heads 60 and fasteners.

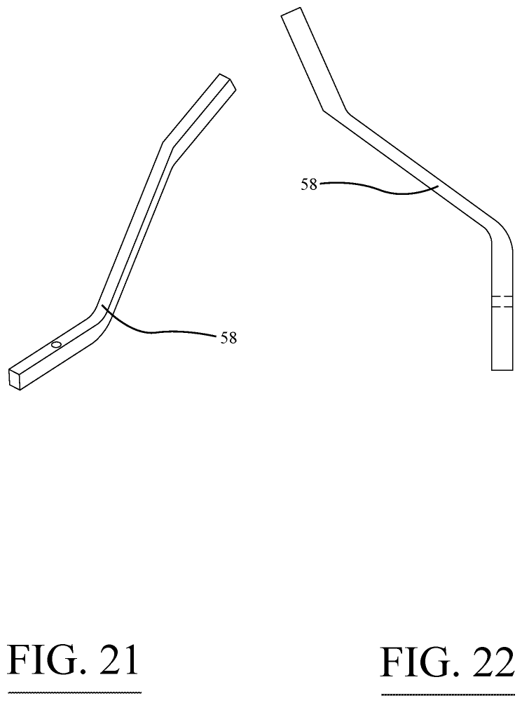

FIG. 21 is a perspective view of adjustable 4 ball massage mounting hook 58.

FIG. 22 is a side view of adjustable 4 ball massage mounting hook 58.

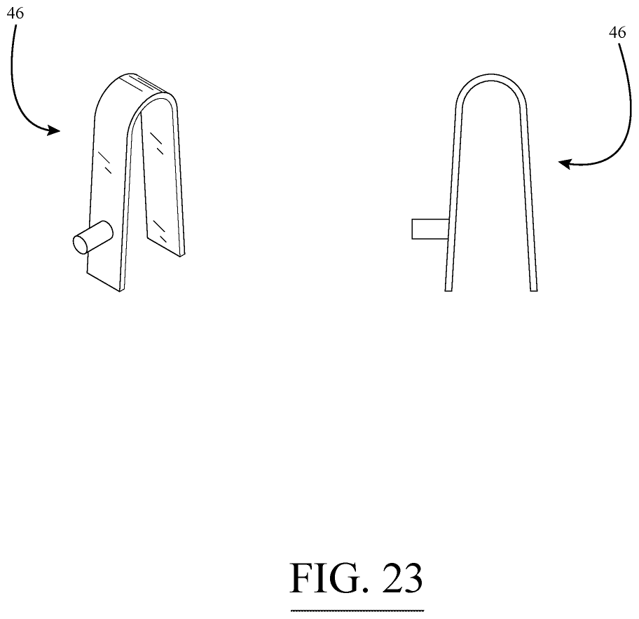

FIG. 23 shows single button spring clips or button locks 46.

FIG. 24 is a perspective view of an oblate spheroid massage device 60.

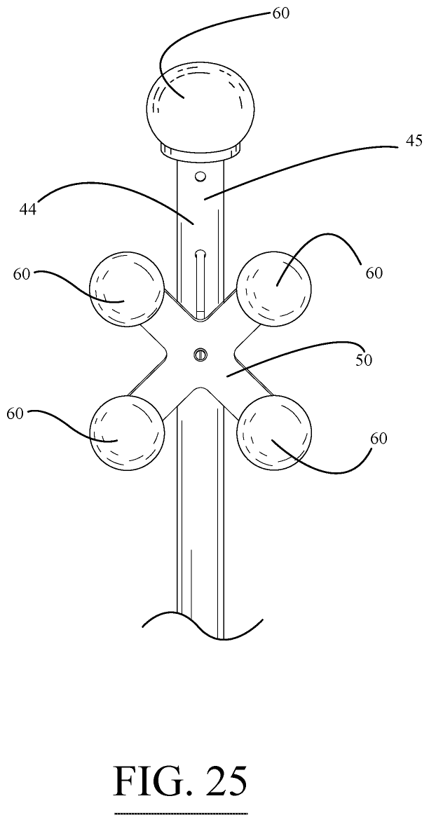

FIG. 25 is a close up front elevation view of an “X” shaped massage bracket 50 and a massage head 60 connected to each branch or arm of the “X” shaped massage bracket 50.

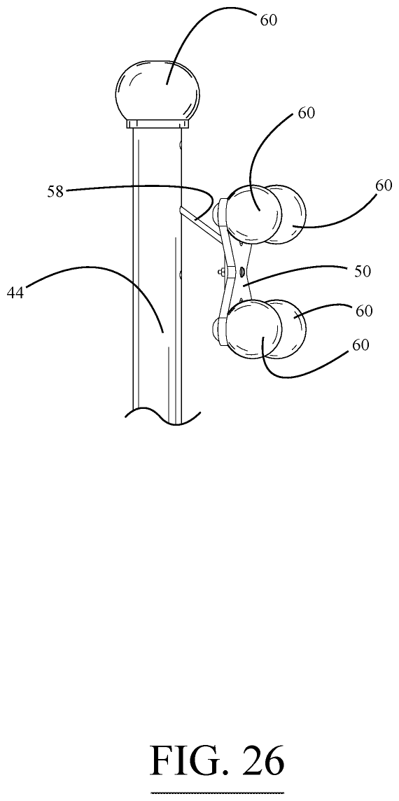

FIG. 26 is a left side elevation view of the embodiment in accordance to FIG. 25.

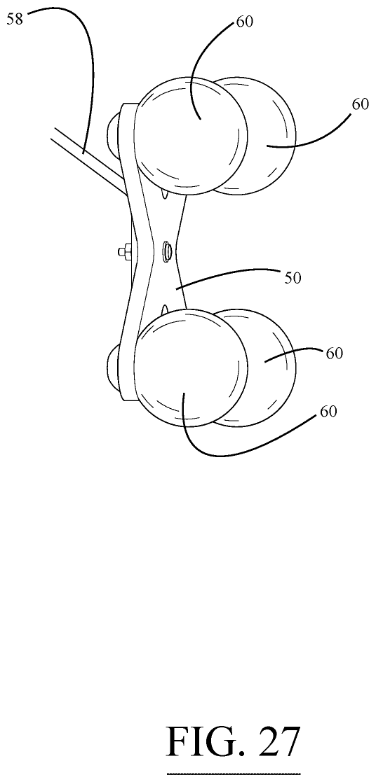

FIG. 27 is a close up left side view of the massage bracket 50 and four massage heads 60.

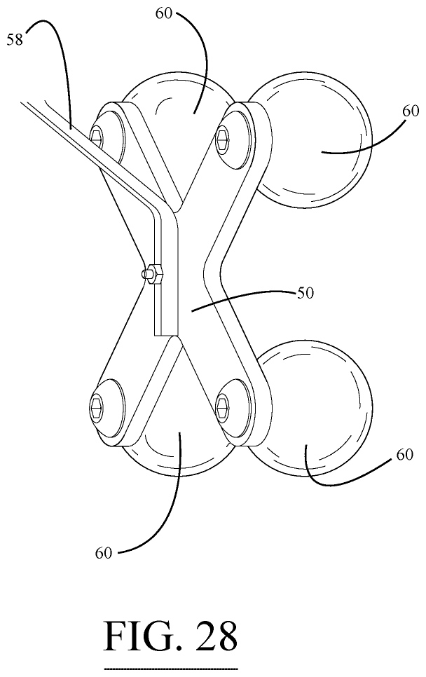

FIG. 28 is a close up left rear view of the massage bracket 50 and four massage heads 60.

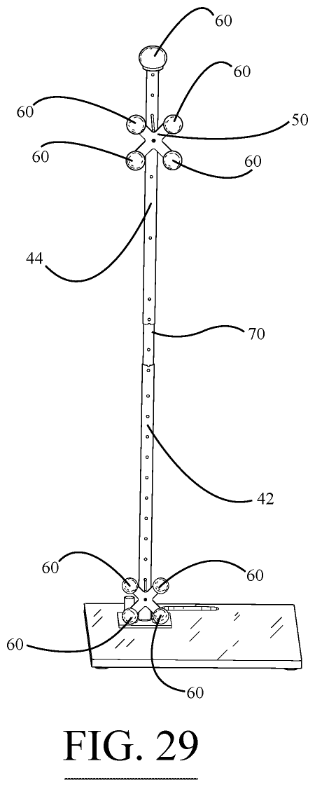

FIG. 29 shows the device 10 adapted with multiple massage brackets, having at massage heads, positioned in a neck, head and foot massage positions. Note that the brackets 50 positioned at the neck and foot massage positions are “X” shaped brackets 50 with a massage head at each of the branches of the bracket, while the massage head 60 at the head massage position is a single oblate spheroid massage device 60.

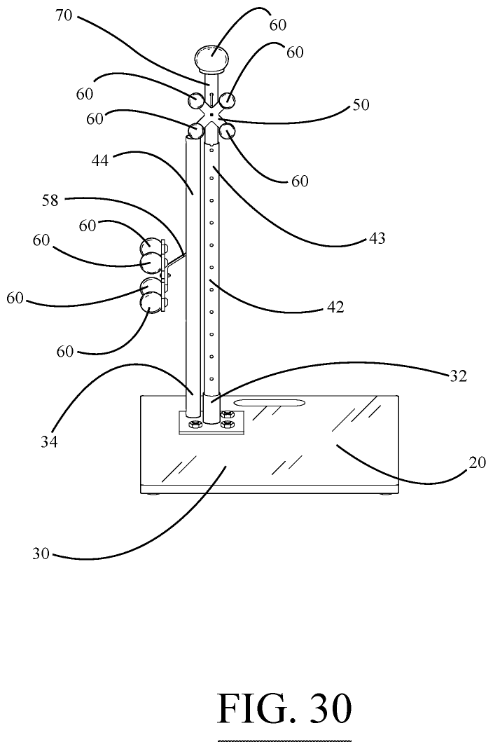

FIG. 30 shows the device 10 adapted in a glutes and hamstring position. As shown, the upper pole 44 is removed from the lower pole 42, secured to the storage receiver 34 and has a X-shaped massage bracket 50 with massage heads 60 for massage of the hamstring. The lower pole 42 is fit with the X-shaped massage bracket 50 positioned near its distal end 43 and has a single oblate spheroid massage device 60 for massage of the glutes.

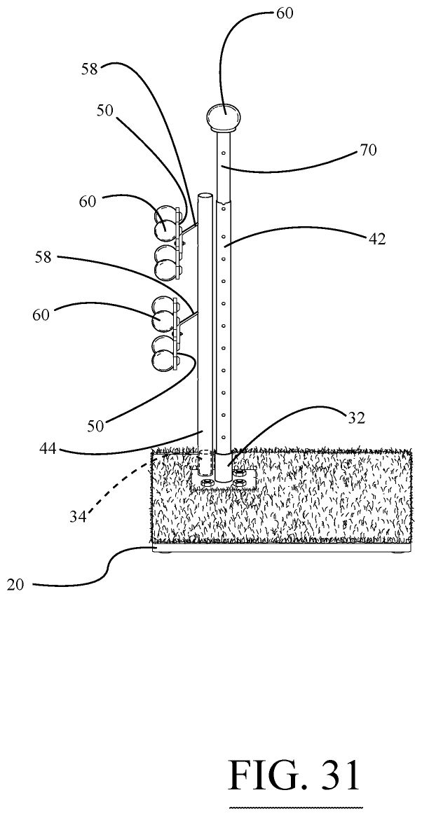

FIG. 31 shows the device 10 adapted in a golf swing training position, with the upper pole 44 secured to the storage receiver 34 and having two massage brackets 50, each having four massage heads 60 connected thereto. The lower pole 42 is secured to the base receiver 32 and has a single oblate spheroid massage device 60 connected near the distal end 43 thereof. Note that the surface of the platform 20 is covered in artificial turf to simulate a golf course playing field.

When using the device as a golf swing practice aid, the golfer sets the telescoping post as if to massage the gluteus maximus. Then, taking a normal golf stance on the base platform, the golfer slightly rests the gluteus maximus against the oblate spheroid placed on the top of the telescoping pole. As the backswing is initiated and rotation of the shoulders and hips begins, the device keeps the golfer's weight on the inside of the back foot. The device stops the golfer from “swaying” off balance thus producing a more powerful swing. More power, more distance.

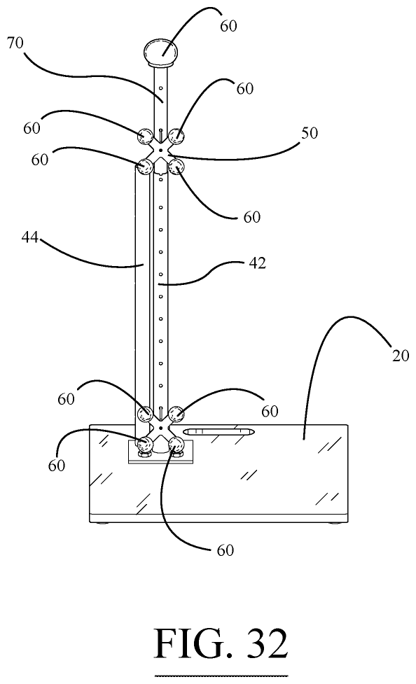

FIG. 32 shows the device in mid and lower back, and foot massage positions. As shown, only the lower pole 42 is actually employed and the upper pole 44 is stored away in the storage receiver 34. The lower pole 42 is equipped with one X-shaped massage bracket 50 positioned near the base of the lower pole 42. An extension pole 70 is inserted into the lower pole 42 and one X-shaped massage bracket 50 is positioned near the distal end 43 of the lower pole 42 and a single oblate spheroid massage device 60 is positioned on top of the extension pole 70.

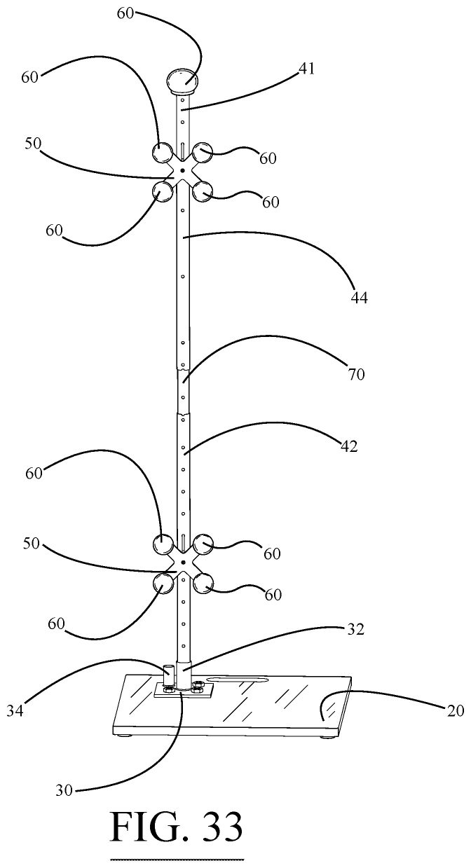

FIG. 33 shows the device in the neck, shoulders and calf massage positions. As shown, an upper pole 44 and an extension pole 70 are interconnected with the lower pole 42 which is secured to the receiver 32 on the base 30. A single oblate spheroid massage device 60 is positioned near the distal end 41 of the upper pole 44 and a X-shaped bracket 50 is positioned adjacent the distal end 41. As shown, the X-shaped bracket 50 has a massage head 60 connected to each of the branches thereof. Finally, an X-shaped bracket 50 is also positioned near a mid-point on the lower pole 42 to provide massage of the calf muscles.

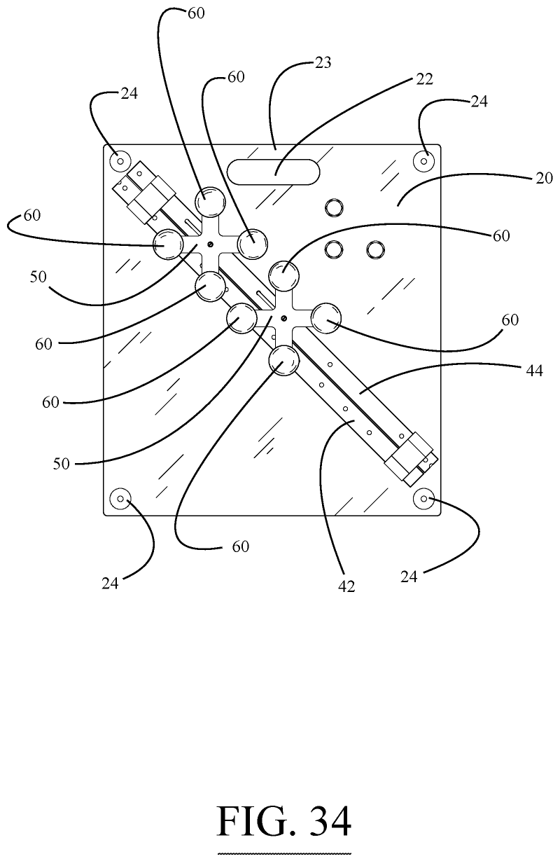

FIG. 34 shows the device 10 in a storage position on the underside of the platform 20.

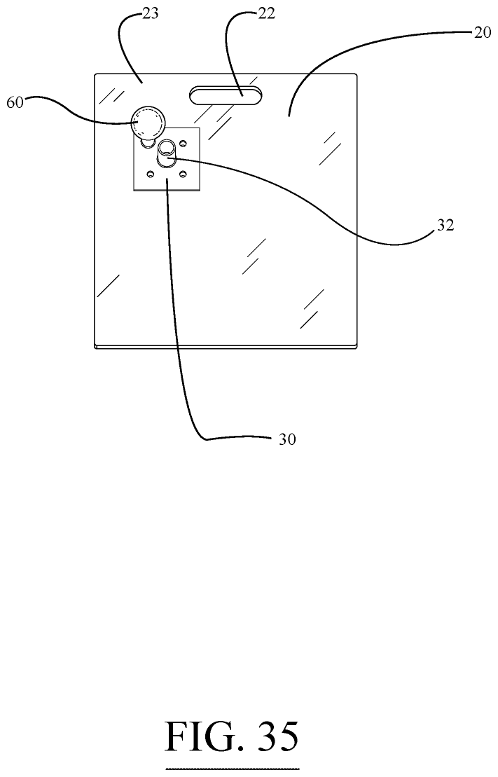

FIG. 35 shows the device 10 in accordance to the embodiment shown in FIG. 34, where the single oblate spheroid massage device 60 is stored by securing it in the storage receiver 34.

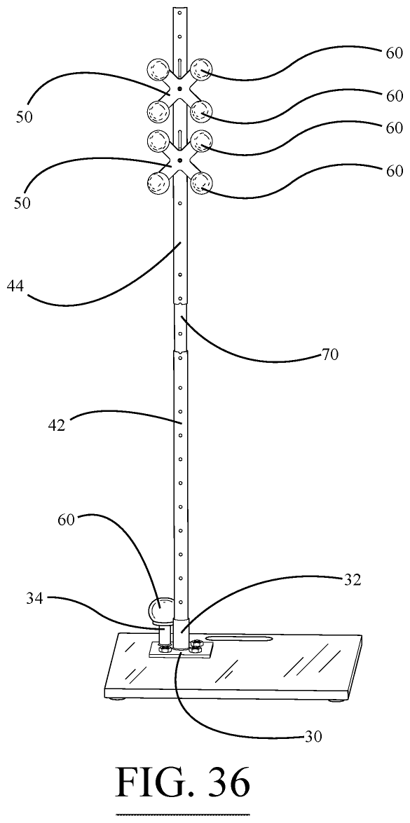

FIG. 36 shows the device 10 adapted to provide massage to the upper back and shoulders regions as well as the foot. As shown, the lower pole 42 is interconnected to the extension pole 70 and the upper pole 44. Positioned at desired heights, two X-shaped brackets 50 with massage heads 60 are placed to provide massage for the upper back and shoulders. A single oblate spheroid massage device 60 is secured to the storage receiver 34 to provide massage to the foot.

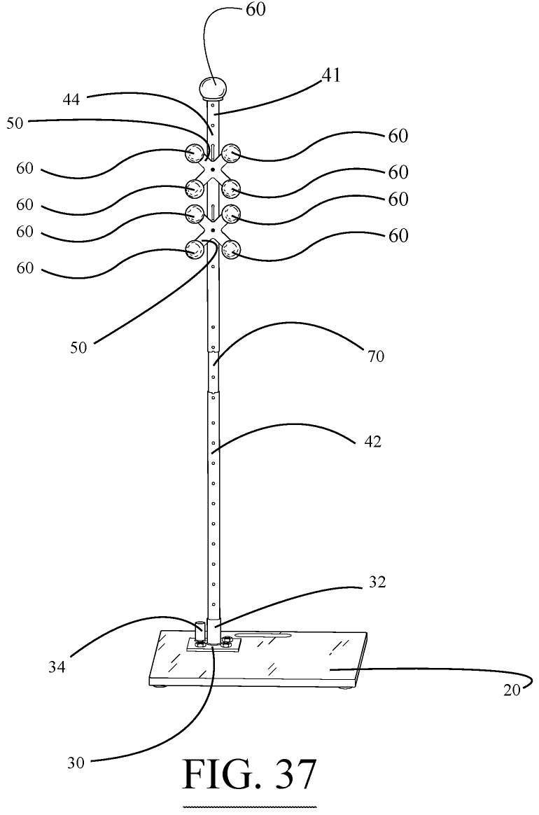

FIG. 37 shows the device 10 adapted to provide massage to the upper back and shoulders and the head. In this embodiment, the single oblate spheroid massage device 60 is positioned near the distal end 41 of the upper pole 44 to provide massage of the head.

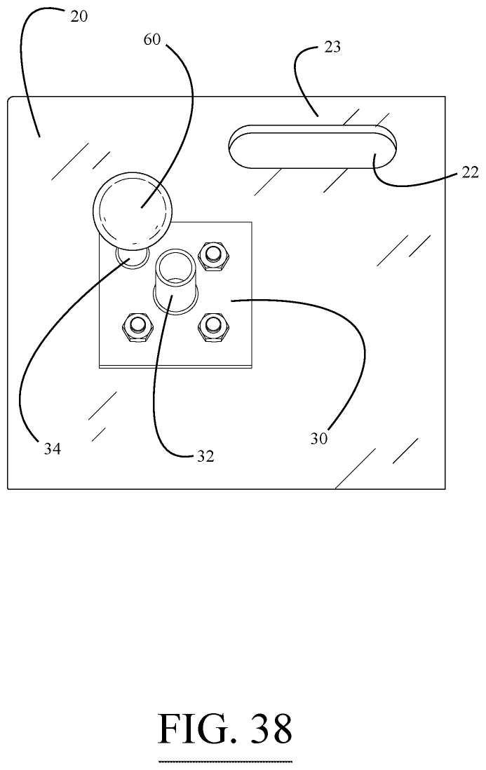

FIG. 38 is a close up view of the embodiment in accordance to FIG. 35.

It is readily apparent that the aforedescribed massage device 10 offers numerous advantages. For example, embodiments of the massage device 10 as described above are advantageous for the following reasons: (i) the device 10 is compact, (ii) the device 10 is portable, (iii) the device 10 is very effective for whole body massage, (iv) the device 10 is capable of delivering both Swedish and acupressure massage to the whole body, (v) the device 10 is hands-free, (vi) the device 10 is relatively inexpensive, (vii) the device 10 is cost effective and more readily available than other therapies, (viii) the device 10 is self-contained, as there are no batteries or electricity required for the device 10, (ix) the device 10 is suitable for both indoor and outdoor use, (x) the device 10 obviates the need to wait for a second party or practitioner for therapy, (xi) the device 10 is durable, and (xii) the device 10 works well with a stand up desk.

Advantageously, the exemplary massage device 10 described above is particularly adapted for therapeutic self-massage, self myofascial release of tension in muscle and tissue in the whole body. The massage device 10 is also able to provide stimulation to acupressure points located throughout the body to increase blood/lymphatic circulation and promote a sense of physical and mental well-being. In addition, the massage device 10 is able to strengthen core muscles of the user's body, thus bringing a general overall sense of physical and mental well-being to the user. Another advantage of the massage device 10 is that one cannot only massage nearly 95% of the body (top of the head excluded), but also simultaneously strengthen core muscles needed to maintain a strong and healthy body. Yet another advantage is that the massage device 10 adjusts to a multiplicity of configurations for all parts of the body in a short period of time (e.g., in mere seconds). Still another advantage is that the massage device 10 is 100% self-contained and portable. The massage device 10 is not anchored to a wall or mounted on a door.

Exemplary embodiments of the massage device 10 as described above are advantageous for the following additional reasons: (i) the device 10 is easy to use, (ii) the device 10 is easily adjustable, (iii) the device 10 provides benefit to the user by releasing tension with self-massage in the whole body and promotes a feeling of physical and mental well-being, (iv) the device 10 is a free standing self-massage apparatus, (v) the device 10 is self-contained and there are no tools required for adjustment, and (vi) the device 10 is unique in the field of self-massage and self myofascial release by enabling effective massage of muscles, self myofascial release, stimulating acupressure points and simultaneous strengthening of core muscles.

Any of the features or attributes of the above described embodiments and variations can be used in combination with any of the other features and attributes of the above described embodiments and variations as desired.

Although the invention has been shown and described with respect to a certain embodiment or embodiments, it is apparent that this invention can be embodied in many different forms and that many other modifications and variations are possible without departing from the spirit and scope of this invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A massage device, comprising:
a base assembly, the base assembly configured to be disposed on a support surface;
at least one pole member configured to be coupled to the base assembly, the at least one pole member configured to extend upwardly from a top surface of the base assembly; and
at least one massage head configured to be selectively coupled to the at least one pole member by a user, the selective coupling of the at least one massage head to the at least one pole member enabling the massage device to provide a massage to various parts of a user's body.

2. The massage device according to claim 1, wherein the base assembly further comprises a base platform member and a base bracket member attached to the base platform member, the base platform member configured to accommodate the user in a standing position thereon such that a weight of the user enhances a structural stability of the massage device and prevents the massage device from tipping or falling over during use, and the base bracket member configured to couple the at least one pole member to the base platform member.

3. The massage device according to claim 2, wherein the base bracket member of the base assembly comprises at least one pole receiver element configured to be coupled to a lower end of the at least one pole member.

4. The massage device according to claim 2, wherein the base platform member of the base assembly comprises a handle cutout for facilitating a carrying of the massage device during transportation thereof by the user.

5. The massage device according to claim 4, wherein the base platform member of the base assembly further comprises a plurality of feet for balancing the base platform member and preventing damage to floor surfaces.

6. The massage device according to claim 1, wherein the at least one pole member comprises a plurality of telescoping pole members for enabling a vertical extending height of the massage device to be selectively adjusted by the user so as to reach the various parts of the user's body.

7. The massage device according to claim 6, wherein the plurality of telescoping pole members comprise a first lower pole member, a second intermediate pole member, and a third upper pole member, the second intermediate pole member being telescopically received in the first lower pole member, and the third upper pole member being telescopically received by the second intermediate pole member so as enable the vertical extending height of the massage device to be selectively adjusted by the user.

8. The massage device according to claim 7, wherein a selected position of the second intermediate pole member relative to the first lower pole member is configured to be maintained by a first position locking device, and a selected position of the third upper pole member relative to the second intermediate pole member is configured to be maintained by a second position locking device.

9. The massage device according to claim 8, wherein at least one of the first position locking device and the second position locking device comprises a snap button spring clip.

10. The massage device according to claim 1, wherein the at least one massage head comprises a plurality of massage heads rotatably and/or pivotably attached a massage bracket member, the massage bracket member configured to be coupled to the at least one pole member by a connector member.

11. The massage device according to claim 10, wherein the at least one pole member comprises a plurality of holes disposed along a length thereof, and wherein the connector member is configured to be inserted by the user into a selected one of the plurality of holes disposed along the length of the at least one pole member so as to enable the massage device to provide a hands free massage to the various parts of the user's body.

12. The massage device according to claim 11, wherein the connector member has a cross-sectional size that is less than an opening size of the plurality of holes of the at least one pole member so as to enable the massage bracket member with the plurality of massage heads to rotate and/or pivot relative to the at least one pole member, while still support a portion of the user's weight applied to the massage bracket member.

13. The massage device according to claim 10, wherein the at least one massage head further comprises an oblate spheroid massage head with a connector post configured to be inserted into a top end of the at least one pole member.

14. The massage device according to claim 1, wherein the at least one pole member is configured to be disassembled from the base assembly by the user without the use of tools so that the massage device is able to be easily and compactly transported and stored.

15. The massage device according to claim 1, wherein the selective coupling of the at least one massage head to the at least one pole member enables the massage device to be selectively configured into a plurality of different functional positions, the plurality of different functional positions being selected from the group consisting of: (i) an upper back massage position; (ii) a neck and head massage position; (iii) a calf and head massage position; (iv) a foot and head massage position; (v) a neck, head and foot massage position; (vi) a glutes and hamstring position; (vii) a golf swing training position; (viii) a mid and lower back, and foot massage position; (ix) a neck, shoulders and calf massage position; (x) an upper back, shoulders and foot massage position; (xi) an upper back, shoulders and head massage position; and
(xii) combinations thereof.

16. The massage device according to claim 1, wherein, while providing a massage to the various parts of the user's body, the massage device is configured to simultaneously strengthen core muscles of the user's body.

17. The massage device according to claim 1, wherein the massage device is configured to be portable, transportable, and free-standing without attachment to a building support element.
